(19) United States
(12) Patent Application Publication
(10) Pub. No.: US 2012/0133476 A1
(43) Pub. Date: May 31, 2012

(54) NON-CONTACT TRANSFORMER

(75) Inventor: Jin Yeong PARK, Gwangju (KR)

(73) Assignee: SAMSUNG MEDISON CO., LTD.

(21) Appl. No.: 13/306,436

(22) Filed: Nov. 29, 2011

(30) Foreign Application Priority Data
Nov. 29, 2010 (KR) 10-2010-0119441

(51) Int. Cl. H01F 27/28

(52) U.S. Cl. 336/220

(57) ABSTRACT

A non-contact transformer includes a first core and a second core. The first core includes a first main body, a first coil-winding part extending from the first main body and having a primary winding wound around the first coil-winding part, and a first extending part extending from the first main body to be spaced apart from the first coil-winding part. The second core includes a second main body positioned to face the first main body, a second extending part extending from the second main body towards the first main body, and a second coil-winding part around which a secondary winding is wound.

### TECHNICAL FIELD

The present disclosure relates to a non-contact transformer and, more particularly, to a non-contact transformer which has improved energy transfer efficiency by reducing leakage flux between a first core and a second core in the non-contact transformer.

### BACKGROUND

A transformer is a static device that transfers electrical energy from one circuit to another using inductively coupled conductors to increase or decrease electromotive force or voltage in the transformer's core. In particular, non-contact transformers enable the transfer of electrical energy without a physical connection between different circuits. Accordingly, non-contact transformers have been used in various types of special-purpose devices. Examples of such devices include, but are not limited to, non-contact electrical power chargers, waterproof electronic devices, and other non-contact energy transfer devices.

However, due to a relatively large gap between the circuits or cores within non-contact transformers, these types of transformers provide lower energy transfer efficiency in comparison to contact-type transformers.

### SUMMARY

The following description relates to a non-contact transformer which has improved energy transfer efficiency by reducing leakage flux between a first core and a second core in the non-contact transformer.

In accordance with one aspect, a non-contact transformer includes a first core including a first main body, a first coil-winding part extending from the first main body and having a primary winding wound around the first coil-winding part, and a first extending part extending from the first main body to be spaced apart from the first coil-winding part; and a second core including a second main body positioned to face the first main body, a second extending part extending from the second main body towards the first main body, and a second coil-winding part around which a secondary winding is wound.

The first extending part may include a first extending subpart which is positioned at one end of the first main body and extends towards the second main body; and a second extending subpart which is positioned at the other end of the first main body and extends towards the second main body.

The second extending part may extend from both ends of the second main body towards the first extending subpart and the second extending subpart.

The second extending part may extend closer to the first main body than end portions of the first and second extending subparts.

The second core may further include a first flux-bunching prevention part. The first flux-bunching prevention part is formed in a curved shape on each corner between the second main body and the second extending part. The first core further includes a second flux-bunching prevention part.

The second extending part may be disposed on an inner side of the first extending part.

### BRIEF DESCRIPTION OF THE DRAWINGS

The figures depict one or more implementations in accord with the present teachings, by way of example only, not by way of limitation. In the figures, like reference numerals refer to the same or similar elements.

FIG. 1 is a cross-sectional view of a conventional non-contact transformer.

FIG. 2 is a cross-sectional view of a non-contact transformer according to an exemplary embodiment of the present disclosure.

FIG. 3A is a perspective view of a first core of the non-contact transformer of FIG. 2.

FIG. 3B is a perspective view of a second core of the non-contact transformer of FIG. 2.

FIG. 4 is a perspective view of a combination of the first core and the second core in FIGS. 3A and 3B.

FIG. 5 is a cross-sectional view of a housing incorporating a second core in the non-contact transformer according to the exemplary embodiment.

FIG. 6 illustrates flux distribution in a conventional non-contact transformer and an exemplary non-contact transformer.

FIG. 7 illustrates flux densities at specific points in a conventional non-contact transformer and an exemplary non-contact transformer according to the present disclosure.

FIG. 8 is a cross-sectional view of a non-contact transformer according to another exemplary embodiment of the present disclosure.

### DETAILED DESCRIPTION

In the following detailed description, numerous specific details are set forth by way of example in order to provide a thorough understanding of the relevant teachings. It should be noted that the following description is provided for illustrative purposes only and not to limit the scope of the following claims.

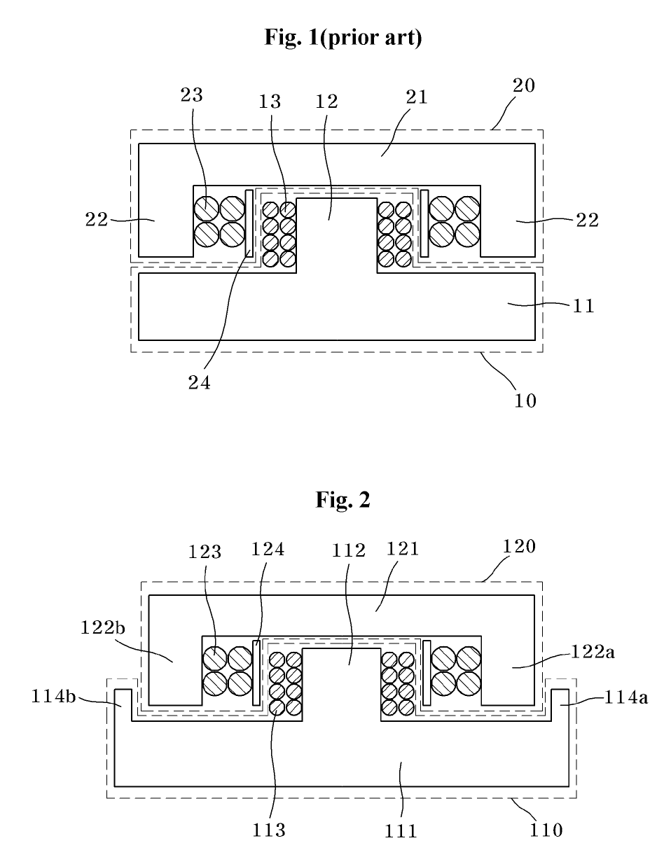

FIG. 1 is a cross-sectional view of a conventional non-contact transformer. Referring to FIG. 1, the non-contact transformer includes a first core 10 and a second core 20. The first core 10 includes a first main body 11 and a first coil-winding part 12 around which a primary winding 13 is wound. The second core 20 includes a second main body 21, a second coil-winding part 24, and an extending part 22. A secondary winding 23 is wound around the second coil-winding part 24.

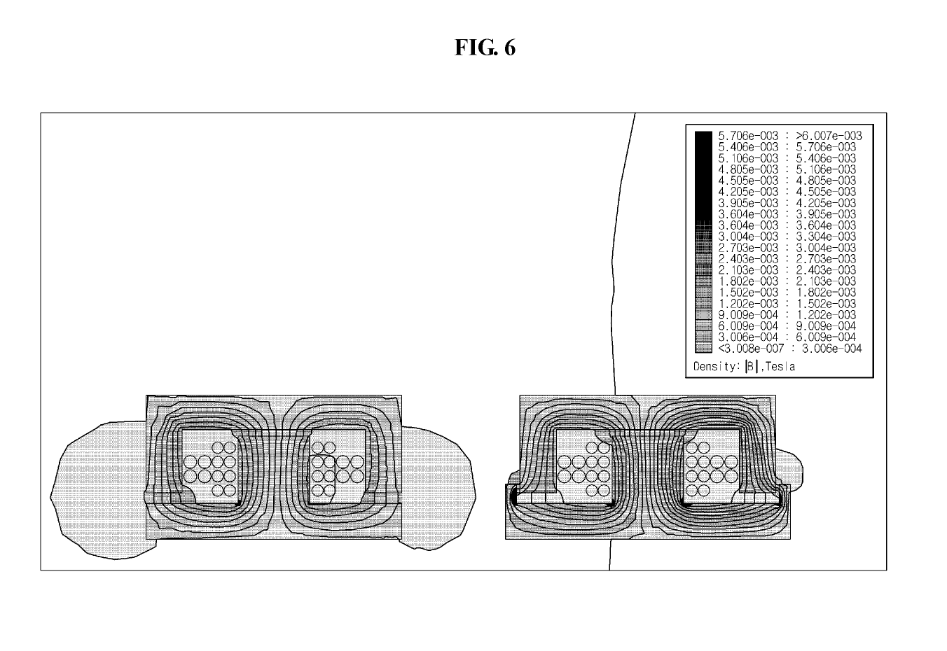

FIG. 6 illustrates flux distribution in a conventional non-contact transformer 610 (e.g. the non-contact transformer of FIG. 1) and an exemplary non-contact transformer 620, in accordance with an embodiment, as will be described in further detail below. As shown in the example of FIG. 6, it can be seen that the conventional non-contact transformer 610 suffers a great amount of flux leakage between the first core 612 and the second core 614, resulting in relatively large energy loss in an energy transfer process from a primary winding of first core 612 to a secondary winding of second core 614, and thus decreased energy transfer efficiency.

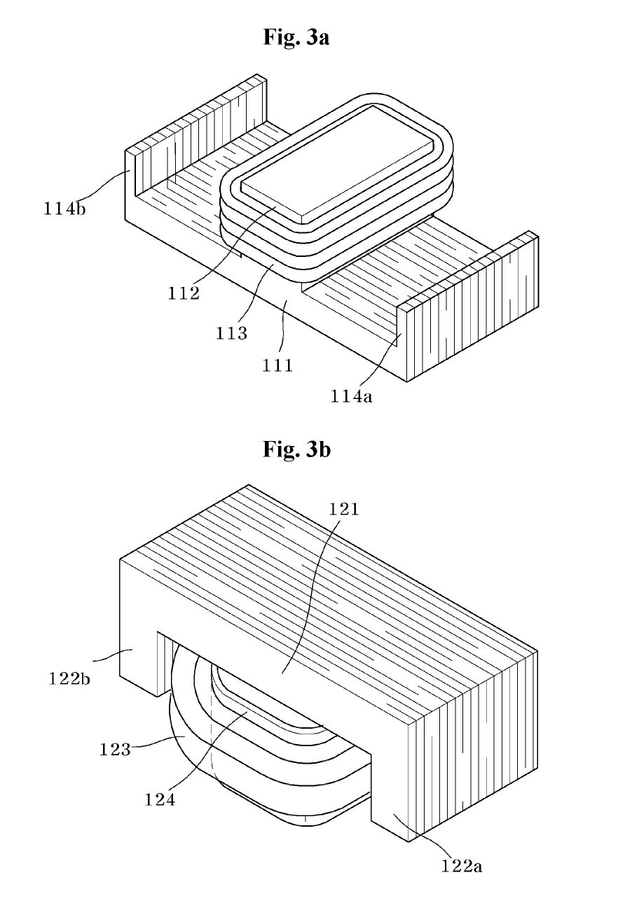

FIG. 2 is a cross-sectional view of a non-contact transformer according to an exemplary embodiment of the present disclosure, FIG. 3A is a perspective view of a first core of the non-contact transformer of FIG. 2, and FIG. 3B is a perspective view of a second core of the non-contact transformer of FIG. 2.

Referring to FIGS. 2 to 3B, an exemplary non-contact transformer includes a first core 110 and a second core 120. The first core 110 includes a first main body 111, a first coil-winding part 112, and a first extending part 114 including parts 114a and 114b. The first coil-winding part 112 extends from the first main body 111 and has a primary winding 113 wound around the first coil-winding part 112. he first extending parts 114a and 114b extend from opposite sides of the first main body 111 and are spaced apart from the first coil-winding part 112. The second core 120 includes a second main body 121, a second extending part 122 including parts 122a and 122b, and a second coil-winding part 124. The second main body 121 is positioned to face the first main body 111. The second extending parts 122a and 122b extend from opposite sides of the second main body 121 toward the first main body 111. A secondary winding 123 is wound around the second coil-winding part 124.

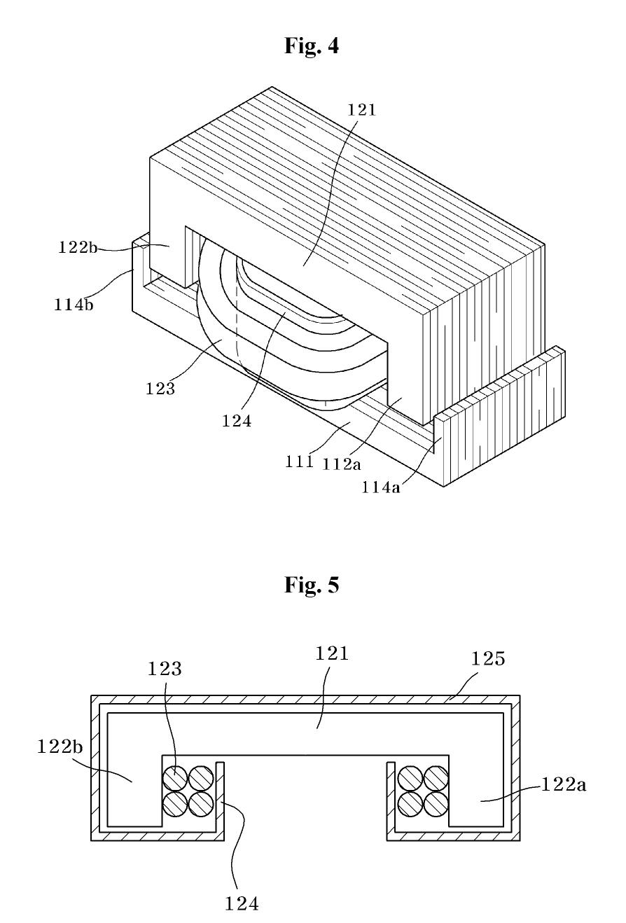

The non-contact transformer thus configured will be described in detail with reference to FIGS. 2 to 8.

Referring to FIGS. 2 to 4, the second extending parts 122a, 122b extend closer to the first main body 111 than end portions of the first extending parts 114a, 114b. The second extending parts 122a, 122b are positioned on an inner side of the first extending parts 114a, 114b. That is, when the first core 110 and the second core 120 in the exemplary non-contact transformer are inductively coupled to each other to transfer electrical energy, the end portions of the first extending parts 114a, 114b are extended from the first main body 111 and positioned to surround the second extending parts 122a, 122b.

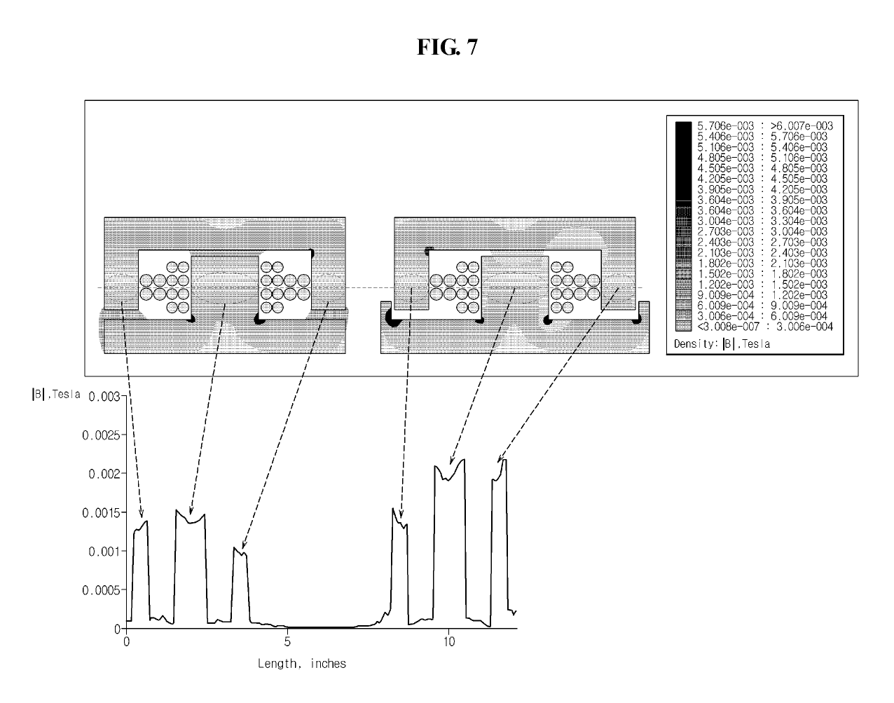

As a result, the non-contact transformer according to the embodiment exhibits significantly reduced flux leakage between the first core 110 and the second core 120. That is, in this embodiment, the first core 110 is inductively coupled to the second core 120 so that the first extending parts 114a, 114b surround the second extending parts 122a, 122b of the second core 120. Accordingly, the first and second extending parts of the first core 110 and the second core 120, respectively, may serve as a flux path between the first core and the second core, thereby reducing leakage flux. As illustrated in FIG. 6, the non-contact transformer 620, according to an embodiment, exhibits significantly reduced leakage flux compared to the conventional non-contact transformer 610, as described above. As a result, the non-contact transformer 620 exhibits a greater flux density at each corresponding core than the conventional non-contact transformer 610, as shown in FIG. 7, thus leading to increased energy efficiency.

FIG. 5 is a cross-sectional view of a housing 125 incorporating the second core 120 in a non-contact transformer, according to an embodiment. Although FIG. 5 shows the second coil-winding part 124 and the housing 125 as being combined, the second coil-winding part 124 and the housing 125 securing the second core 120 may be separate from one another. For example, the second coil-winding part 124 may be provided in the housing 125 by means of a suitable connecting or coupling member.

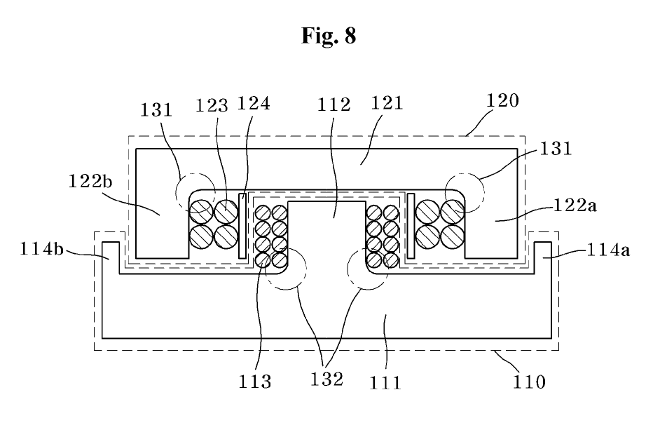

Referring to FIG. 8, the second core 120 may further include a flux-bunching prevention part 131. As shown in the example of FIG. 8, the flux-bunching prevention part 131 may be formed in a curved shape on each corner between the second main body 121 and the second extending part 122a, 122b. The first core 110 may also further include a flux-bunching prevention part 132, which may be formed in, for example, a curved shape on each corner between the first main body 111 and the first coil-winding part 112. As a result, it is possible to prevent flux bunching at specific points of each core and to obtain a uniformly distributed flux density, thereby significantly reducing a so-called edge effect. That is, the exemplary non-contact transformer does not exhibit flux bunching at specific points of each core, such as corners of each core. Since the non-contact transformer includes the flux-bunching prevention parts 131 and 132 on corners of each core, this exemplary non-contact transformer has a uniformly distributed flux density on each core. Hence, the non-contact transformer according to the exemplary embodiment does not undergo a sharp increase of heat at specific points of each core, thereby significantly reducing energy loss caused by the heat. As a result, the energy transfer efficiency of the non-contact transformer is increased accordingly.

As apparent from the above description, the exemplary non-contact transformer exhibits increased electrical energy transfer efficiency by adding an extending part, which extends from each end of the main body of the first core towards the second core, so as to reduce leakage flux between the first core and the second core.

Further, the exemplary non-contact transformer exhibits increased energy transfer efficiency by further including a flux-bunching prevention part to decrease energy loss caused by heat.

While the foregoing has described what are considered to be the best mode and/or other examples, it is understood that various modifications may be made therein and that the subject matter disclosed herein may be implemented in various forms and through various examples, and that the teachings may be applied in numerous applications, only some of which have been described herein. It is intended by the following claims to claim any and all applications, modifications and variations that fall within the true scope of the present teachings.

What is claimed is:

1. A non-contact transformer comprising:
a first core including a first main body, a first coil-winding part extending from the first main body, the first coil-winding part having a primary winding wound around the first coil-winding part, and a first extending part extending from the first main body, the first extending part being spaced apart from the first coil-winding part; and
a second core including a second main body positioned to face the first main body of the first core, a second extending part extending from the second main body towards the first main body, and a second coil-winding part around which a secondary winding is wound.

2. The non-contact transformer of claim 1, wherein the first extending part of the first main body comprises:
a first extending subpart that is positioned at a first end of the first main body and that extends towards the second main body of the second core; and
a second extending subpart that is positioned at a second end opposite to the first end of the first main body and that extends towards the second main body.

3. The non-contact transformer of claim 2, wherein the second extending part of the second main body includes at least two extending subparts that extend from opposite ends of the second main body toward the first extending subpart and the second extending subpart of the first main body.

4. The non-contact transformer of claim 3, wherein the second extending part of the second main body extends closer to the first main body than end portions of the first and second extending subparts.

5. The non-contact transformer of claim 3, wherein the second core further includes a first flux-bunching prevention part.

6. The non-contact transformer of claim 5, wherein the first flux-bunching prevention part is formed in a curved shape on each corner between the second main body and the second extending part.

7. The non-contact transformer of claim 6, wherein the first core further includes a second flux-bunching prevention part.

8. The non-contact transformer of any one of claim 1, wherein the second extending part is disposed on an inner side of the first extending part.

9. The non-contact transformer of any one of claim 1, wherein the primary winding and the secondary winding are spaced apart from each other.
